(19) United States
(12) Patent Application Publication
(10) Pub. No.: US 2025/0037047 A1
(43) Pub. Date: Jan. 30, 2025

(54) SYSTEMS AND METHODS OF METADATA-BASED TASK SHARING ACCESS AND TRACKING

(71) Applicant: WELLS FARGO BANK, N.A., San Francisco, CA (US)

(72) Inventors: Niraj Pandey, Edison, NJ (US); Dmitry Sukner, Brooklyn, NY (US)

(73) Assignee: WELLS FARGO BANK, N.A., San Francisco, CA (US)

(21) Appl. No.: 18/494,038

(22) Filed: Oct. 25, 2023

Related U.S. Application Data
(60) Provisional application No. 63/515,916, filed on Jul. 27, 2023.

(51) Int. Cl. G06Q 10/0631

(52) U.S. Cl. CPC G06Q 10/06311

(57) ABSTRACT

Systems and methods of metadata-based task access and tracking including: receiving a selection of a source backlog from a set of backlogs; generating a list of tasks associated with the source selection; determining a subset of backlogs from the set of source backlogs based on user account data; receiving a selection of a target backlog from the subset of backlogs; receiving a selection of a task from the list of tasks associated with the source backlog; cloning the selected task from the source backlog to the target enterprise backlog such as by applying a metadata label to the target enterprise backlog associated with the target selection.

### CROSS-REFERENCE TO RELATED APPLICATION

The present patent application claims of the benefit of U.S. Patent Application No. 63/515,916 titled “METADATA-BASED TASK SHARING ACCESS AND TRACKING” filed Jul. 27, 2023, the entire contents of which are incorporated by reference herein for all purposes.

### FIELD OF INVENTION

The present disclosure generally relates to metadata-based task sharing, task tracking and control of access to assigning tasks, and more particularly to systems and methods for using metadata to share tasks, track task progress, and control assignment of tasks across an enterprise.

### BACKGROUND

In enterprises, there are oftentimes identical or near-identical tasks implemented by multiple teams. Enterprise rules or regulations may require tasks be executed in a particular order, based on the backlog or the team. For example, enterprise rules may require that developers on different teams execute similar tasks for their respective backlogs, such as implementing particular features across multiple backlogs, one such example being standardizing authentication protocols across multiple backlogs. Task reporting applications are useful for enterprises by assisting enterprises in identifying inefficiencies in teams, however current task reporting applications are ill-suited for controlling assignment of tasks across enterprises and controlling access to shared tasks. Current task reporting applications do not use metadata labels to control tracking and to share tasks across teams or divisions of an enterprise.

### SUMMARY

In an aspect, an example method includes receiving a selection of a source backlog from a set of backlogs; determining a subset of backlogs from the set of source backlogs; receiving a selection of a task from the list of tasks associated with the source backlog; generating a list of tasks associated with the source backlog selection; receiving a selection of a target backlog from the subset of backlogs; cloning the selected task from the source backlog to the target backlog such as by applying a metadata label to the target enterprise backlog associated with the target backlog selection.

In a further aspect, further example methods include generating a list of tasks. The list of tasks may be associated with the source selection, associated with past tasks completed by the user, or associated with a user's task or backlog search history. In some examples, the list of tasks may be based on the user account data, such as including tasks that are associated with the user's profession. In another aspect, further example methods may include generating a list of recommended backlogs, wherein the list of recommended backlogs is based on one or more of a backlog search history of a user and user account data.

In a further aspect, further example methods include receiving a selection of a target backlog. The user may select the target backlog from a list of backlogs. The list of backlogs may include a subset of backlogs to which the user has authority to access and clone tasks. Metadata labels for the backlog or tasks of the backlog may indicate that a task was cloned to a backlog, a user that cloned the task, when the task was cloned, and the backlog from which the task was cloned. An enterprise may also predetermine or preset a user's user account data to include the user's profession, title, name, team, division of enterprise, security level, security clearance, and information associated with user authority to access backlogs and clone tasks. In some examples, the list of backlogs is a subset of the backlogs arranged based on the user account data. For example, the list of backlogs may include backlogs associated with a user's team.

In a further aspect, further example methods include receiving a selection of a task from the list of tasks. Users may select multiple tasks. In some examples, the tasks are divided into subtasks that users may individually select, add, exclude from selection, or edit. In an additional aspect, further example methods include generating a report based on the metadata label, wherein the report includes one or more hyperlinks to one or more of a user guide, description, and user notes for performing the cloned task.

In a further aspect, further example methods include cloning the selected task from the selected source backlog to the selected target backlog. Cloning may include applying or editing metadata labels to a task linking or copying the task to the target backlog.

The above methods can be implemented as computer-executable program instructions stored in a non-transitory, tangible computer-readable medium or media and/or operating within a processor or other processing device and memory.

### BRIEF DESCRIPTION

A full and enabling disclosure is set forth more particularly in the remainder of the specification. The specification makes reference to the following appended figures.

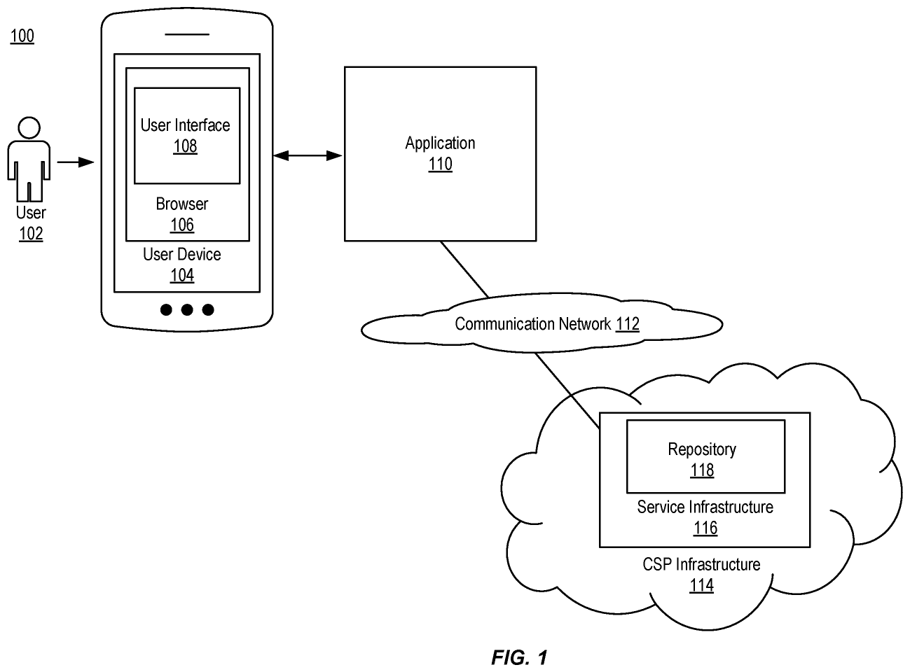

FIG. 1 illustrates an example system for metadata-based task access and tracking.

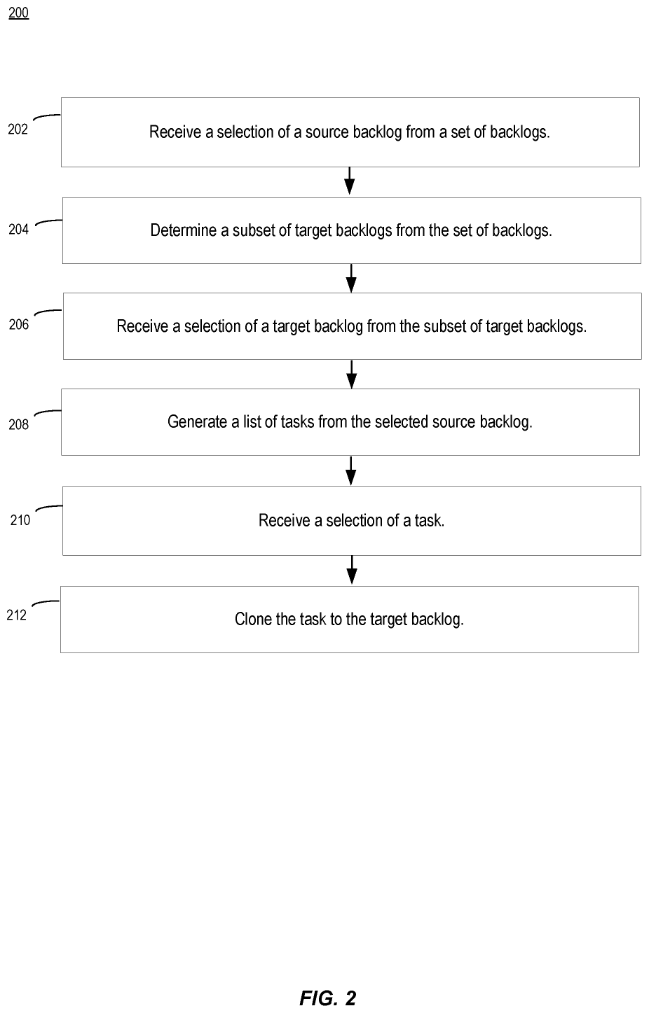

FIG. 2 illustrates a flow chart for a method of metadata-based task access and tracking.

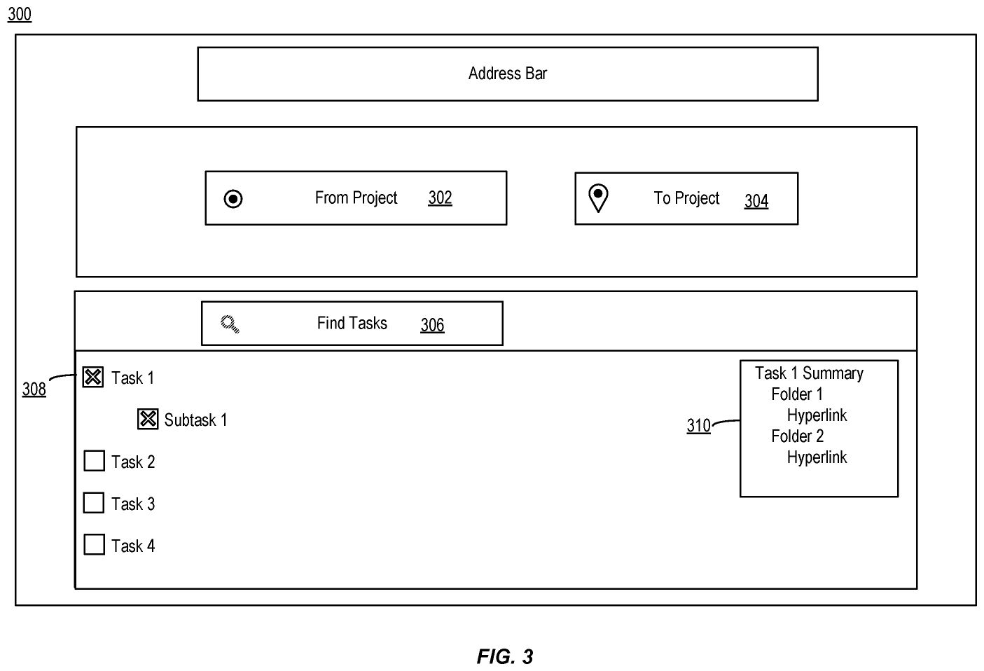

FIG. 3 illustrates an example block diagram of a user interface of a system for metadata-based task access and tracking.

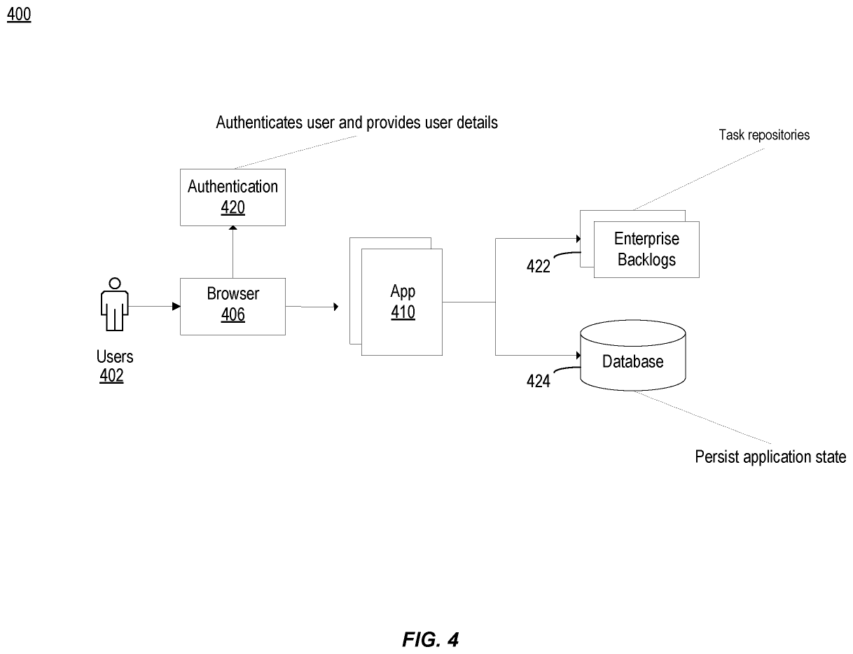

FIG. 4 illustrates an example of system architecture of a system for metadata-based task access and tracking.

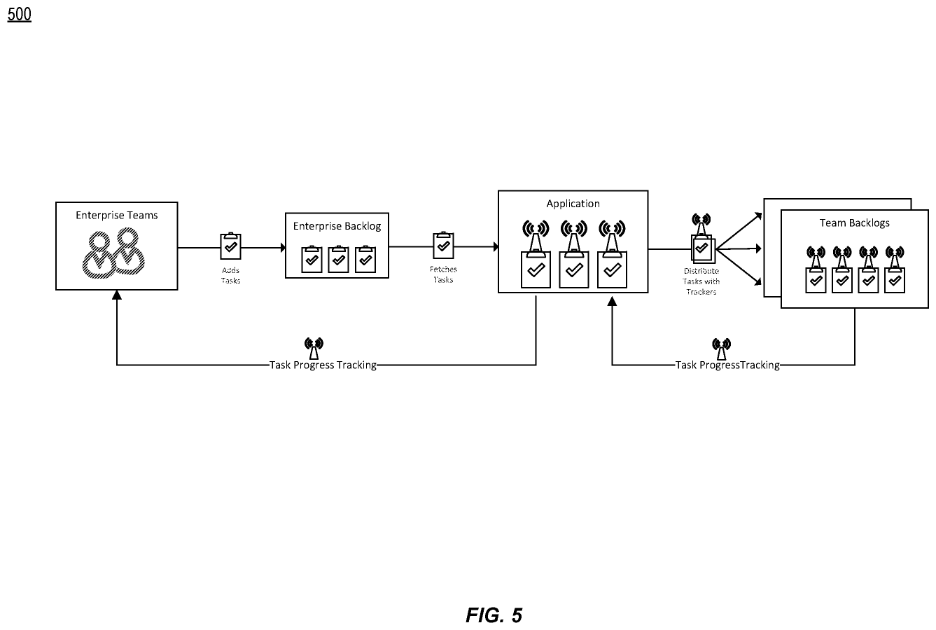

FIG. 5 illustrates an example of data flow for the cloning of tasks.

### DETAILED DESCRIPTION

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

### Illustrative Embodiment of Metadata Progress Reporting

In one illustrative embodiment, a system for metadata progress reporting comprises an application for using metadata to track progress of tasks and to control sharing of tasks across teams and backlogs. Users may access the application through a browser or application executed locally on a user device. Backlogs are dynamic and prioritized lists of tasks of a software project for developers to execute. Backlogs allow developers to track the status of individual tasks and overall software projects, and are editable, allowing developers to copy, add, remove, and edit tasks within the backlog as features and requirements of a software project change. In some examples, backlogs are associated with various enterprise actions, such as developing or updating products and services of the enterprise. The backlogs may include various tasks, which divide the enterprise actions into actions executable by workers of the enterprise. For example, a backlog for the development of a user interface for a mortgage lending application may be divided into several tasks, such as integrating Application Programming Interfaces (APIs) between the mortgage lending application and another application allowing communication of data between the applications or adding multi-factor authentication (MFA) to the mortgage lending application's login process. Backlogs may include links to resources to assist with executing tasks from the backlog, for example by linking users through a hyperlink to user guides, manuals, templates, and past solutions to tasks. In some examples, developers may adjust the order of tasks within a backlog to prioritize tasks and assign timelines to tasks to indicate when developers should complete tasks. A few non-limiting examples of backlogs may include Jira backlogs, Scrum backlogs, and Kanban backlogs.

The application receives input from a user through a user interface. The user interface includes various search boxes, checkboxes, and input fields to allow users to search for backlogs and select tasks. For example, the user interface may include a first input field to select a backlog. Users may input a name of a backlog and select a backlog from a list of backlogs associated with the input name. Based on the selected backlog, the user interface may adapt or update to include a list of tasks associated with the selected backlog. Users may interact with the list of tasks through the user interface to select tasks to clone, such as by clicking on a checkbox.

In some examples, the user interface may access user account data to identify backlogs or tasks recently accessed by the user, most often accessed by users, and flagged backlogs or tasks to include in a prominent position of the list of backlogs or tasks, such as at the top of the list. In some examples, the user interface may include a favorites tab for flagged backlogs or tasks.

Cloning of tasks between backlogs may include adding metadata associated with the task or backlogs and copying the task to a list of tasks of a backlog. For example, cloning includes applying metadata labels to the tasks and backlogs indicating that a task was cloned, the user that cloned the task, when the task was cloned, and the backlog from which the task was cloned.

The application may receive input from the user into a second input field to select a target backlog to which to add the selected tasks. For example, the user may determine that a mobile application for a brokerage service should include a new logo and user interface already implemented in a mobile application for retirement accounts. The user may select in a first input field the backlog associated with the mobile application for retirement accounts, select the tasks executed in the backlog associated with implementing the new logo and user interface, and select in the second input field the backlog associated with the mobile application for retirement accounts. The user may confirm his or her selections and clone the selected tasks to the backlog associated with the mobile application for retirement accounts.

The enterprise may control user access to certain backlogs or tasks. For example, the enterprise may determine that users may only access backlogs and tasks assigned to them or their team. The enterprise may further restrict access to backlogs and tasks based on a user's job title or profession, such as restricting backlogs associated with an accounting issue to only accountants or software development issues to only software developers.

The application receives input from a user, such as a selection or a search inquiry, through a user interface. The application copies tasks from one backlog to another backlog and applies or edits metadata labels associated with the copy and backlogs to indicate the task has been cloned and to control access to the backlog.

The application uses account data to determine user access to backlogs. For example, a user who is a software developer may have access to the software backlogs associated with his or her team or division of an enterprise. The user may select from the user interface, a backlog to copy a task or set of tasks from. The user interface displays a list of recommended backlogs, such as recent backlogs searched by the user, from which the user may select a backlog to view tasks The second input field may display a subset of backlogs that the user is granted access for task cloning. The user interface displaying the backlogs may also include links to resources to assist with executing tasks from the backlog. For example, the user interface may provide tools or materials to users by linking users through a hyperlink to user guides, manuals, templates, and past solutions to tasks.

The application may report progress of the users in completing tasks and user activity from cloning tasks. For example, the application may generate a report based on the metadata labels identifying backlogs including cloned tasks.

### System for Metadata Progress Reporting

FIG. 1 illustrates a metadata progress reporting system 100. The metadata progress reporting system 100 includes an application 110, with a user interface 108 accessible through a browser 106 executed on a user device 104. The metadata progress reporting system 100 further includes a communication network 112, cloud service provider infrastructure 114, and repository 118.

In some examples, the application 110 is executed on the user device 104 or service infrastructure 116 provided on the cloud service provider infrastructure 114.

A user 102 provides inputs to the user interface 108 accessible through a browser 106 executed on a user device 104. The application 110 receives the user 102 input and communicates through the communication network 112 to service infrastructure 116 operating on cloud service provider infrastructure 114. Service infrastructure 116 associated with the application 110 may include a repository 118. The repository 118 may store metadata labels associated with the tasks and backlogs. In some examples, a second repository may store the backlogs and tasks.

In some examples, the application 110 may be two separate applications, a first application associated with editing the backlogs and tasks, and the second application associated with applying or editing the metadata labels and cloning tasks. For example, the first application may be an issue and backlog tracking software such as Jira, and the second application may be a separate application communicating with and using stored backlogs and issues from Jira.

### Illustrative Methods of Operating a Metadata-Based Task Access and Tracking System

FIG. 2 is a flowchart showing illustrative method 200 for operating a metadata-based task access and tracking system. In some examples, some of the steps in the flow chart of FIG. 2 are implemented in program code executed by a processor, for example, the processor in a general-purpose computer, mobile device, or server. In some examples, these steps are implemented by a group of processors. In some examples the steps shown in FIG. 2 are performed in a different order or one or more steps may be skipped. Alternatively, in some examples, additional steps not shown in FIG. 2 may be performed.

At block 202, the method 200 receives a selection of a source backlog from a set of backlogs. A user may input the selection into an input field of a user interface of the system, such as by typing a name of a backlog into the input field to cause a set of backlogs (e.g., a list of backlogs) associated with the typed name to be displayed. The user may click his or her selected backlog from the set. In other examples, the user interface initially displays a preliminary list of backlogs based on backlogs worked on or previously selected by the user. In further examples, the user interface may include a favorites tab of backlogs.

At block 204, the method 200 determines a subset of target backlogs from the set of backlogs. In some examples, the method uses user account data to determine backlogs accessible to the user that users may select as a target backlog. For example, the user account data may include information associated with the user's title, team, division of the business, profession, and assigned backlogs. The target backlogs may include backlogs that the user has authority to edit based on the user account data. Whether a backlog is accessible to the user may further be based on metadata labels specifying individual users or required matching user account data to determine whether a user may clone tasks to backlogs. When the user account data does not match the requirements of the metadata labels, the application may prevent users from cloning tasks to the backlogs or not display the backlogs to which the user does not have access.

At block 206, the method receives a selection of a target backlog from the subset of target backlogs. The user may select the backlog to which the user intends to clone a task. In some examples, the user may select multiple backlogs to which the user intends to clone a task. For example, a user may select a plurality of backlogs associated with a team of developers or a particular product and service to which the user may clone a task.

At block 208, the method generates a list of tasks. The list of tasks may include tasks associated with the source backlog. For example, the list of tasks may include tasks in progress or completed for the source backlog from block 202. In some examples, the list of tasks may include tasks that users of a similar title, profession, user's security clearance, or division of an enterprise to the user executed for the source backlog. In further examples, the list of tasks includes tasks associated with the user. For example, when the user specializes in network security, the list of tasks may include tasks particular to a backlog's network security, such as conducting malware scans or developing software patches.

At block 210, the method 200 receives a selection of a task. The user selects a task from the list of tasks generated at block 204 to clone to the target backlog selected at block 206. The user may select multiple tasks to clone to the target backlog.

At block 212, the method 200 clones the task to the target backlog. Cloning may include adding a copy of the selected task from the source backlog to the target backlog. Cloning may further include applying a metadata label to one or both of the source backlog and target backlog. In some examples, the metadata label indicates that a task was cloned to a backlog, the user that cloned the task, when the task was cloned, and the backlog from which the task was cloned.

### Illustrative User Interface

FIG. 3 illustrates an example user interface 300 of a system for metadata-based task access sharing and tracking. The user interface 300 includes various elements and input fields including a From Backlogs field 302, To Backlogs field 304, Find Tasks search bar 306, task selection field 308, and task summary area 310.

Users may search for backlogs in the From Backlog field 302 to identify backlogs from which the user intends to clone tasks. The user may input a string to the From Backlog field to search for backlogs associated with the string. The user may select a backlog from the results of the search.

Users may select a backlog from the To Backlog field 304 backlogs to which the user intends to clone tasks. The user may input a string to the From Backlog field to search for backlogs associated with the string. Results from the search may be based on user account data. The results may include backlogs to which the user has authority to clone tasks. The user may select the backlog from the results of the search.

Users may search for tasks associated with the backlog selected in the From Backlog field 302 at the Find Tasks search bar 306. The user may input a string into the search bar to identify tasks associated with the string. For example, the user may search “authentication protocol” and receive results for tasks from the source backlog associated various authentication protocols such as multi-factor authentication, challenge-handshake authentication protocols, and password authentication. The user interface may display the results in the task selection field 308, from which the user may select one or more tasks to clone from the selected backlog of the From Backlog field 302 to the selected backlog of the To Backlog field 304. Tasks may further include subtasks, such as additional tasks nested within a particular task.

When the user selects a task and subtasks from the task selection field 308, the user interface 300 may generate a task summary area 310. The task summary area 310 may include various folders and hyperlinks associated with tasks selected in the task selection field 308. The summary information may include information such as user guides, descriptions, user notes, and tips for executing the task. The summary information may include links to webpages for information associated with the task or the backlog for which the selected task was executed.

### Example System Architecture

FIG. 4 illustrates an example of system architecture for a metadata-based task access sharing and tracking system 400. The metadata-based task access sharing and tracking system 400 includes a browser 406 through which users 402 may interact with application 410, an authentication module 420, enterprise backlogs 422, and a database 424.

The users 402 provide inputs, such as selections of tasks and backlogs, to a browser 406. The browser 406 transmits the inputs to the application 410. The browser may transmit to and receive data from an authentication module 420 to authenticate the user and provide user details such as user account data. The authentication module 420 may be a separate application or service executed on cloud service provider infrastructure and may receive user account data from a local or remote data repository.

The application 410 may transmit to and receive data from the enterprise backlogs 422. The enterprise backlogs may be stored in a repository with tasks, or the tasks may be stored in a separate repository. In some examples, the enterprise backlogs are stored in a repository associated with an additional application, such as Jira. The application 410 may further transmit to and receive data from a database 424. The application may store inputs to the browser 406 such as cloned tasks between backlogs.

### Example Flow of Data

FIG. 5 illustrates an example of the flow of data for a metadata-based task access sharing and tracking system 500. In one example, users of an enterprise team may add tasks to an enterprise backlog, such as one or more source backlogs. An application fetches tasks from the enterprise backlogs and applies trackers to the tasks such as metadata labels. In some examples, users may add tasks to enterprise backlogs using an additional application separate from the application applying trackers. The application distributes the tasks, such as by cloning tasks, with trackers to team backlogs. The team backlogs may be the target backlogs, further described in FIG. 2. Users may input status updates to tasks in the team backlogs, such as indicating when a task is completed, which the user provides to the application and enterprise teams.

### Example Features of Metadata-Based Task Access and Tracking

The application may share tasks among various teams of an enterprise. The tasks may be cross-cutting in nature and repeatable meaning several teams within an enterprise would benefit from implementing particular tasks. The application allows publishing tasks, syncing tasks across multiple teams and tracking the progress of the implementation of tasks. Tasks may be repeatable, may be implemented at certain interval of time or as a reaction to certain reoccurring events. An example of such tasks is a set of minimum requirements that an enterprise determines must be met by an application which is being migrated to the cloud. In an example application that connects to a separate application such as Jira, the requirements may be defined as Jira issues, the specific details for an application development team to implement as a feature of software being migrated to cloud that complies with the requirement set forth in a Jira issue also referred to as a task. These sets of tasks may be implemented by each application development team for the application that is being migrated to cloud. Users may define a task once and distribute a task to all interested teams and users in a seamless more efficient manner and makes it convenient to track and report the progress of the implementation of task. Tasks may be Jira issues (e.g., Epic, Story, Sub-tasks). Users may publish and assign tasks by adding a metadata label to a Jira issue. Additions of metadata labels make Jira issues visible to other teams of an enterprise so that the other teams can create a clone of that issue/task for implementation. In some examples, a software component may interact with additional applications such as Jira share information between applications, allowing users to search Jira issues or cross-cutting tasks, and edit the issues and tasks with further details and to clone issues and tasks in a team's Jira backlog. While cloning Jira issues, the software component may add Jira metadata labels and clone tasks improving user experience of tracking the progress of task implementation. The application may share and report progress of cross-cutting and/or repeatable tasks across teams in an enterprise.

In an enterprise, several cross-cutting tasks may be implemented by various teams. Enterprises may determine to execute tasks across the various teams because of regulatory and compliance requirements, a best practice that has been discovered by a team, or a set of post-production deployment tasks that must be implemented due to technical requirements of a system. Each team may operate based on Jira. Users may define tasks considered by a team as a Jira issue and store the tasks in a Jira backlog. Each task may define requirements and a set of acceptance criteria with details to allow for other teams to implement the task. In order to share a given Jira issue, users may add a Jira metadata label that makes the Jira issue visible in the application for other teams to clone the issue into their backlog. In Jira, access to Jira issues within a backlog may be restricted to the members of the Jira backlog. Adding a special label is a way of giving permission to the application to share such issues with other teams. Other teams can search the catalog of such tasks published by various teams in the application and clone/bring them into their own Jira backlog. The application adds a metadata label and creates relationship that refers the original Jira issue for cloned issues, to track the progress of implementation of tasks across various teams.

The application may leverage widely used Jira and well understood Agile process to define tasks that are easily repeatable to build a sophisticated system to solve the problem of sharing and tracking tasks across an enterprise.

### Example Advantages of Metadata-Based Task Access and Tracking

Systems and methods for metadata-based task access and tracking are useful for enterprises in efficiently standardizing processes across multiple backlogs and implementing past work in future backlogs to improve efficiency in enterprise processes, including improving efficiency in technical fields such as software development. The systems and methods for metadata-based task access and tracking also maintains security of the backlogs across the enterprise by authenticating user identity and authorities based on user account data to determine which users are able to access and clone tasks.

Further, enterprises often require the execution of the same task by many teams, making it more efficient to create the task in one backlog and share that task with delivery teams across an enterprise and track their progress.

### General Considerations

Although the subject matter has been described in language specific to structural features or methodological acts, it is to be understood that the subject matter of the appended claims is not necessarily limited to the specific features or acts described above. Rather, the specific features and acts described above are disclosed as examples.

Various operations of examples are provided herein. The order in which one or more or all of the operations are described should not be construed as to imply that these operations are necessarily order dependent. Alternative ordering will be appreciated based on this description. Further, not all operations may necessarily be present in each example provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has,” “with,” or variants thereof are used in either the detailed description or the claims, such terms are intended to be inclusive in a manner similar to the term “comprising”.

Further, unless specified otherwise, “first,” “second,” or the like are not intended to imply a temporal aspect, a spatial aspect, or an ordering. Rather, such terms are merely used as identifiers, names, for features, elements, or items. For example, a first state and a second state generally correspond to state 1 and state 2 or two different or two identical states or the same state. Additionally, “comprising,” “comprises,” “including,” “includes,” or the like generally means comprising or including.

Although the disclosure has been shown and described with respect to one or more implementations, equivalent alterations and modifications will occur based on a reading and understanding of this specification and the drawings. The disclosure includes all such modifications and alterations and is limited only by the scope of the following claims.

What is claimed is:

1. A method comprising:
receiving a selection of a source backlog from a set of backlogs;
determining a subset of target backlogs from the set of backlogs;
receiving a selection of a target backlog from the subset of target backlogs;
generating a list of tasks from the selected source backlog;
receiving a selection of a task; and
cloning the task to the target backlog.

2. The method of claim 1, wherein cloning includes adding a metadata label associated with the task to the target backlog and copying the task to a list of tasks of the target backlog.

3. The method of claim 1, wherein one or more tasks from the list of tasks are divided into subtasks which a user may select, add, exclude from selection, or edit.

4. The method of claim 1, wherein the list of tasks is based on user account data including one or more of a user's security clearance, profession, job title, and division of an enterprise.

5. The method of claim 2, wherein the metadata label indicates that a task was cloned to a backlog, a user that cloned the task, when the task was cloned, and the backlog from which the task was cloned.

6. The method of claim 4, further comprising:
generating a list of recommended backlogs, wherein the list of recommended backlogs is based on one or more of a backlog search history of a user and user account data.

7. The method of claim 5, further comprising:
generating a report based on the metadata label, wherein the report includes one or more hyperlinks to one or more of a user guide, description, and user notes for performing the cloned task.

8. A system comprising:
one or more processors configured to:
receive a selection of a source backlog from a set of backlogs;
determine a subset of target backlogs from the set of backlogs;
receive a selection of a target backlog from the subset of target backlog;
generate a list of tasks from the selected source backlog;
receive a selection of a task; and
clone the task to the target backlog.

9. The system of claim 8, wherein cloning includes adding a metadata label associated with the task to the target backlog and copying the task to a list of tasks of the target backlog.

10. The system of claim 8, wherein one or more tasks from the list of tasks are divided into subtasks which a user may select, add, exclude from selection, or edit.

11. The system of claim 8, wherein the list of tasks is based on user account data including one or more of a user's security clearance, profession, job title, and division of an enterprise.

12. The system of claim 9, wherein the metadata label indicates that a task was cloned to a backlog, a user that cloned the task, when the task was cloned, and the backlog from which the task was cloned.

13. The system of claim 11, further comprising:
generate a list of recommended backlogs, wherein the list of recommended backlogs is based on one or more of a backlog search history of a user and user account data.

14. The system of claim 12, further comprising:
generate a report based on the metadata label including the cloned task, wherein the report includes one or more hyperlinks to one or more of a user guide, description, and user notes for performing the cloned task.

15. A non-transitory computer readable medium comprising instructions that when executed by one or more processors cause the one or more processors to:
receive a selection of a source backlog from a set of backlogs;
determine a subset of target backlogs from the set of backlogs;
receive a selection of a target backlog from the subset of target backlog;
generate a list of tasks from the selected source backlog;
receive a selection of a task; and
clone the task to the target backlog.

16. The non-transitory computer readable medium of claim 15, wherein cloning includes adding a metadata label associated with the task to the target backlog and copying the task to a list of tasks of the target backlog.

17. The non-transitory computer readable medium of claim 15, wherein one or more tasks from the list of tasks are divided into subtasks which a user may select, add, exclude from selection, or edit.

18. The non-transitory computer readable medium of claim 15, wherein the list of tasks is based on user account data including one or more of a user's security clearance, profession, job title, and division of an enterprise.

19. The non-transitory computer readable medium of claim 16, wherein the metadata label indicates that a task was cloned to a backlog, a user that cloned the task, when the task was cloned, and the backlog from which the task was cloned.

20. The non-transitory computer readable medium of claim 18, further comprising:
generate a list of recommended backlogs, wherein the list of recommended backlogs is based on one or more of a backlog search history of a user and user account data.
